(19) United States
(12) Patent Application Publication
(10) Pub. No.: US 2012/0265486 A1
(43) Pub. Date: Oct. 18, 2012

(54) METHOD FOR ASCERTAINING AND MONITORING FILL LEVEL OF A MEDIUM IN A CONTAINER WITH A TRAVEL TIME MEASURING METHOD

(75) Inventors: Peter Klofer, Steinen (DE); Winfried Mayer, Buch (DE); Dietmar Spanke, Steinen (DE)

(73) Assignee: Endress + Hauser GmbH + Co. KG, Maulburg (DE)

(21) Appl. No.: 13/518,517

(22) PCT Filed: Nov. 11, 2010
(86) PCT No.: PCT/EP10/67254

§ 371 Date: Jun. 22, 2012

(30) Foreign Application Priority Data
Dec. 23, 2009 (DE) 10 2009 055 262.6

(51) Int. Cl. G01B 7/26; G01B 21/18; G06F 15/00

(52) U.S. Cl. 702/166

(57) ABSTRACT

A method for ascertaining and monitoring fill level of a medium in a container by means of a field device with a travel time measuring method, wherein, in a learning phase, application- and device referenced test signals and response signals expected from a fill level upper surface are determined and, therefrom, application- and device referenced comparison signals are ascertained, wherein, in an operational phase, test signals are transmitted toward the medium and application- and device referenced, response signals are received, as well as, by means of a comparison algorithm, the comparison signals are compared with the response signals and a value for an agreement probability is ascertained, and wherein, upon exceeding the ascertained value of the agreement probability above a predetermined limit value, the fill level is ascertained and outputted as a measured value and/or, in the case of subceeding, or falling beneath, the predetermined limit value, a new test signal is transmitted for renewed ascertaining of a response signal.

The present invention relates to a method for ascertaining and monitoring fill level of a medium in a container with a travel time measuring method.

Such methods for ascertaining and monitoring fill level in a container are frequently applied in measuring devices of automation- and process control technology. Available from the assignee, for example, are fill level measuring devices under the marks, Prosonic, Levelflex and Micropilot, which work according to the travel time, measuring method and serve to determine and/or to monitor fill level of a medium in a container. These fill level measuring devices transmit a periodic transmission signal in the microwave- or ultrasonic range by means of a transmitting/receiving element in the direction of the upper surface of a fill substance and receive reflected echo signals after a distance dependent, travel time. Usual fill level measuring devices working with microwaves can be divided basically into two classes. A first class is that, in the case of which the microwaves are sent by means of an antenna toward the fill substance, reflected on the surface of the fill substance and then received back after a distance dependent, travel time. A second class is that, in the case of which the microwaves are guided along a waveguide toward the fill substance, reflected on the surface of the fill substance due to the impedance jump existing there and the reflected waves are then led back along the waveguide.

Formed from the received echo signals is, as a rule, an echo function representing the echo amplitudes as a function of travel time, wherein each value of this echo function corresponds to the amplitude of an echo reflected at a certain distance from the transmitting element.

In this so established echo function, a wanted echo is determined, which corresponds to the reflection of the transmission signal on the surface of the fill substance. From the travel time of the wanted echo, there results, in the case of known propagation velocity of the transmission signals, directly the distance between the fill substance surface and the transmitting element.

In order to simplify the echo curve evaluation, not the received raw signal of the pulse sequences is used, but, instead, the envelope, the so called envelope curve, is ascertained. The envelope curve is won, for example, by rectifying the raw signal of the pulse sequences and then filtered with a lowpass.

Today, fill level sensors working according to the travel time principle determine distance using processing steps as follows: The analog response signal (intermediate frequency signal) obtained as response to the sent test signal is, depending on sensor principle, filtered in analog stages, or, following preceding A/D-conversion, in digital stages, in given cases, transformed from the time, into the frequency, domain, rectified, and transformed into a logarithmic representation. The result of this processing chain of steps is the so-called envelope curve, in which then, by means of various algorithms, the fill-level echo is sought. The selection of the algorithm occurs according to more or less complex rules; in the simplest case, the algorithm searches only for the global maximum of the envelope curve.

In the case of this type of evaluation, the information content of the response signal is strongly reduced by the step fill level echo search and essentially limited to the amplitude information.

A large number of different methods for determining the wanted echo in an envelope curve exist, which can be divided into two basic methods. Either the static detection methods with static echo search algorithms and/or the dynamic detection methods with dynamic echo search algorithms, for example, by applying historical information.

In a first method, a static echo search method, using a static echo search algorithm, the echo having a larger amplitude than the remaining echoes is selected as the wanted echo. Thus, the echo in the envelope curve with the largest amplitude is ascertained to be the wanted echo.

In a second method, a static echo search method, using a static echo search algorithm, it is assumed that the wanted echo is the first echo occurring in the envelope curve after the transmission pulse. Thus, the first echo in the envelope curve is selected as the wanted echo.

It is possible to combine the two methods with one another in a static echo search algorithm by e.g. defining a so-called first echo factor. The first echo factor is a predetermined factor, by which an echo must exceed a certain amplitude, in order to be recognized as wanted echo. Alternatively, a travel time dependent echo threshold can be defined, which an echo must exceed, in order to be recognized as wanted echo.

In a third method, the fill-level measuring device is once told the current fill level. The fill-level measuring device can, based on the predetermined fill level, identify the associated echo as wanted echo and follow such e.g. by a suitable dynamic echo search algorithm. Such methods are referred to as echo tracking. In such case, e.g. in each measuring cycle, maxima of the echo signal or the echo function are determined, and, based on the knowledge of the fill level ascertained in the preceding measuring cycle and an application-specific, maximum expected rate of change of fill level, the wanted echo is detected. From a travel time of the so detected, current wanted echo, there results then the new fill level.

A fourth method is described in DE 102 60 962 A1. There, the wanted echo is detected based on data stored earlier in a memory. In such case, there are derived, from received echo signals, echo functions, which reflect the amplitudes of the echo signals as a function of their travel time. The echo functions are stored in a table, wherein each column serves for accommodating one echo function. The echo functions are stored in the columns in a sequence, which corresponds to the fill levels associated with the respective echo functions. In operation, the wanted echo and the associated fill level are detected based on the echo function of the current transmission signal with the assistance of the table.

In DE 103 60 710 Al a fifth method is described, in the case of which transmission signals are sent periodically toward the fill substance, their echo signals recorded and converted into an echo function, at least one echo characteristic of the echo function is determined, and, based on the echo characteristics of at least one preceding measurement, a prediction is derived for the expected echo characteristics for the current measurement. The echo characteristics of the current measurement are ascertained taking into consideration the prediction, and, based on the echo characteristics, the current fill level is ascertained. This method approaches an echo tracking in the broadest sense.

In DE 10 2004 052 110 A1, a sixth method is described, which achieves improvement of the wanted echo detection by an echo evaluation and classification of the echoes in the envelope curve.

In WO 02065066 A1, a method for highly accurate measuring of fill level is described. The intermediate frequency signal is digitally stored and, thus, both amplitude- as well as also phase information is held available. By applying the digitized, intermediate signal, fill level can be detected with millimeter accuracy.

In DE 4308373 C2, a method is described, which extracts from the envelope curve the echoes and their echo features. Serving as echo features are form factor, position, or point in time, and amplitude of the echo. The form factor feature is, in such case, defined as the ratio between a 6 dB, front edge width to 6 dB, total width of the respective echo. For example, for a symmetric s echo, this value equals ½. With the help of fuzzy logic, the probability for each echo is calculated to be a disturbance echo, multi-echo or wanted echo. The echo with the largest wanted echo probability is selected as wanted echo.

Known from EP 0 459 336 is, moreover, a method for processing ultrasound echo signals, in the case of which the received signal is digitally sampled and stored in a memory, wherein the received signal is the envelope curve of the echo. After registering the received signal, signal processing is used to extract the echoes by means of a suitable method, e.g. optimum filter and a threshold value detection, and all echoes arising within a measuring are detected.

Known, furthermore, are methods for suppressing undesired echoes contained in the received signal, for example, echoes present due to disturbing objects located in the registration region of the sensor supplementally to the measured object. When the disturbing objects are spatially fixed and simultaneously the range of movement of the measured object is limited, then a sufficient suppressing of disturbing echoes can be achieved by suitable choice of the evaluation time window.

Known from DE 33 37 690 is a method, by which disturbing object echoes can be suppressed by features including that, in a learning phase, in the case of which the measured object is not located in the registration region of the sensor, first of all, all disturbing object echoes are detected and stored in a memory. During measurement operation, the currently detected echoes are compared with the learned echos. In the case of sufficient agreement, the echo is classified as a disturbing object echo and correspondingly suppressed, while the remaining echos are associated with measured objects.

In the documents DE 33 37 690 and EP 0 459 336, moreover, methods are described, which mask out disturbing echoes caused by multiple reflections between the sensor and an object in such a manner that the maximum travel time to be evaluated is limited and echoes occurring outside this travel time are ignored. In the case of the solution illustrated in EP 0 459 336, supplementally, also echo amplitude can be evaluated as a criterion for multi-echo suppression.

Known from DE 38 21 577 is a method for suppressing disturbing echoes based on plausibility examinations. Since the gradient, with which the measuring situation can change is limited due to the finite movement velocity of objects, echoes only evaluated when their time position and amplitude are sufficiently plausible based on preceding measuring situations. In this way, above all, stochastically occurring disturbance signals can be safely suppressed.

These above described methods work, to the extent of their disclosures, quite well in a large number of applications. Problems always occur, however, when the echo coming from the fill level cannot with the method be identified without there being some doubt as to the correctness of the identification and the wanted echo signal is jumping, due to process conditions.

If, mistakenly, another echo than the fill-level echo is classified as the wanted echo, the is the danger that a wrong fill level is output, without this being noticed. This can, depending on application, lead to an overfilling of containers, to pumps running dry or to other happenings connected, in given cases, with considerable danger.

Due to the above described measurement problems, a wrong or unsettled measured value ascertainment of fill level of the medium in a container can occur. In the worst case, a so-called echo loss occurs, in the case of which the wanted echo signal can no longer be identified, or found.

An object of the invention is to provide a more reliable and rapid method for identification of wanted echo signals in response signals of fill level measuring devices working according to the travel time measurement principle.

This object of the invention is achieved by the method features set forth in claim 1.

Advantageous further developments of the invention are given in the dependent claims.

Other details, features and advantages of the subject matter the invention will become evident from the following description with the associated drawings, in which preferred examples of embodiments the invention are presented. In the examples of embodiments of the invention shown in the figures, for purposes of perspicuity and simplification, elements, which correspond to one another in their construction and/or in their function, are provided with equal reference characters. The figures of the drawing show as follows:

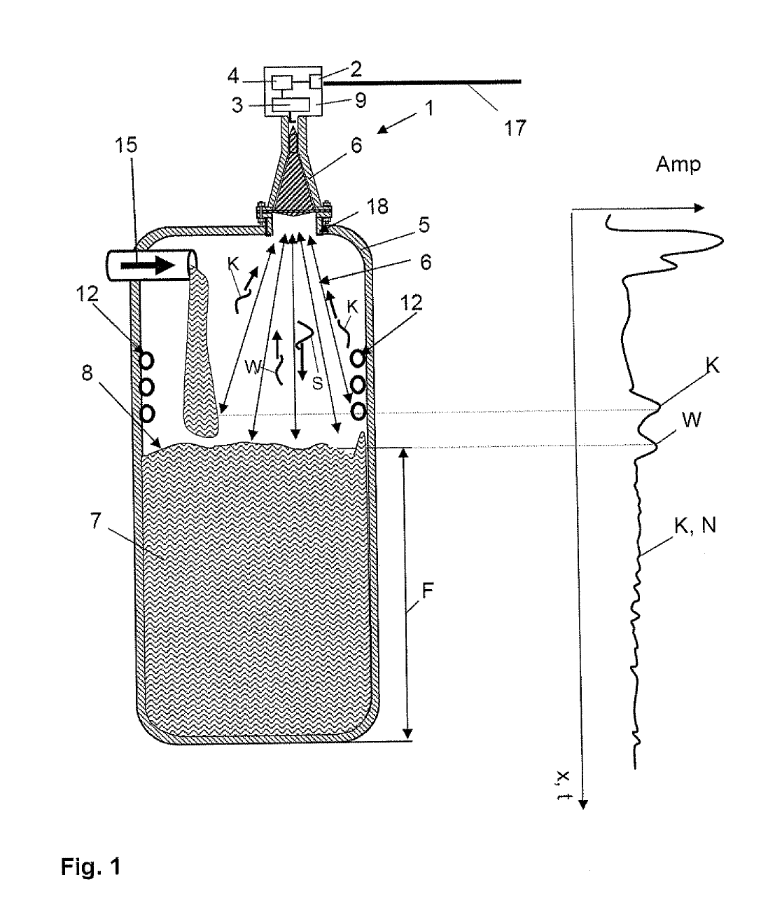

FIG. 1 a example of an embodiment of a measuring device for ascertaining fill level, including a corresponding envelope curve;

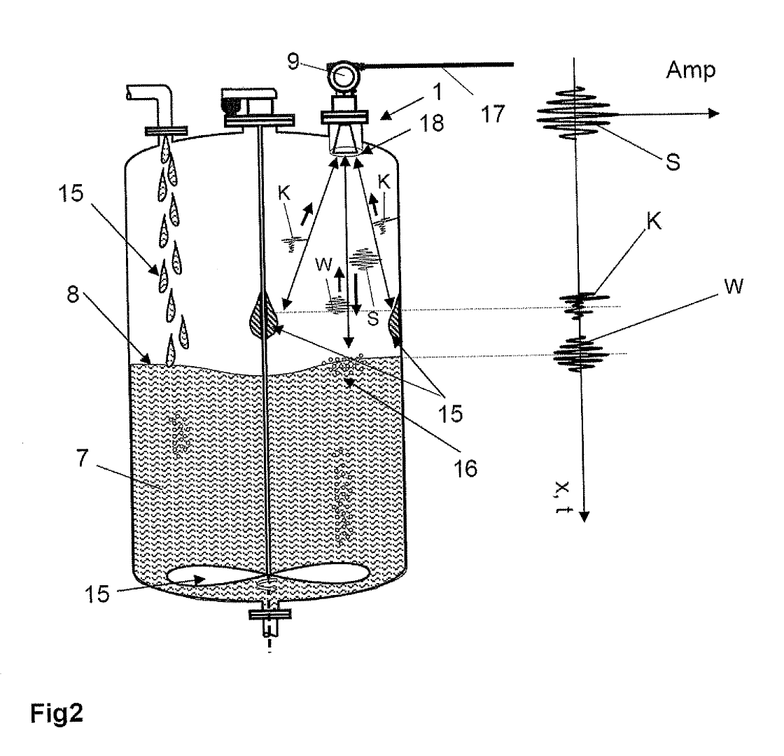

FIG. 2 an example of the invention for an embodiment of a measuring device for ascertaining fill level by means of the method of the invention for identification of the wanted echo signal in the response signals;

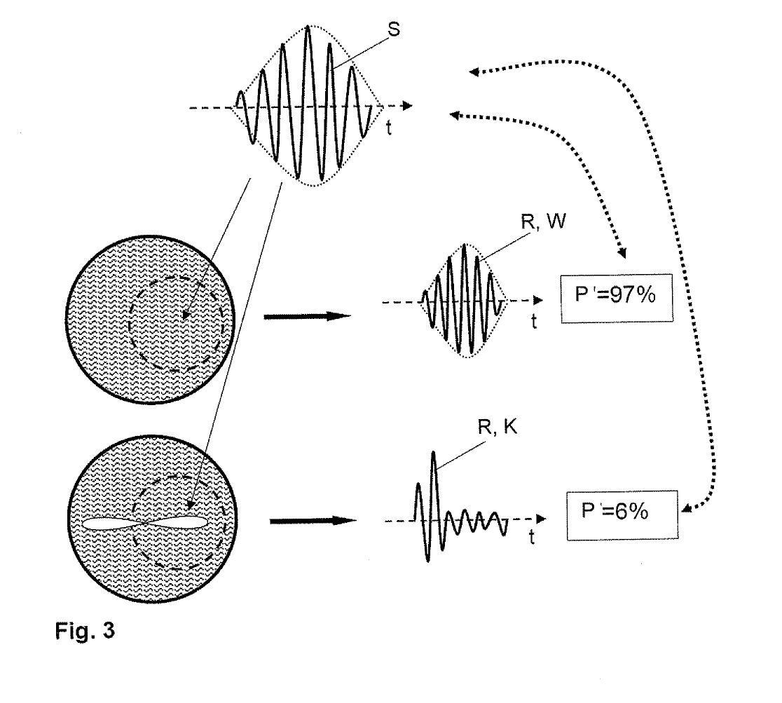

FIG. 3 an example of intermediate frequency signals of a planar fill level upper surface and from a disturbance element; and

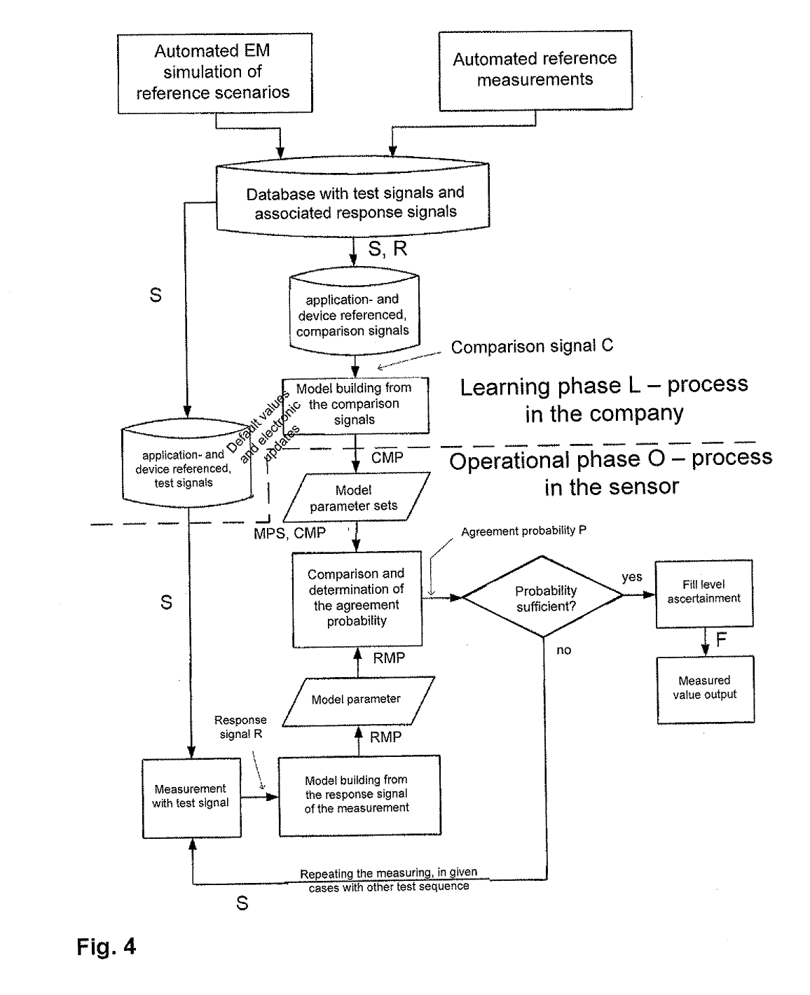

FIG. 4 a method of the invention useful for distinguishing disturbing echoes and wanted echo from the planar fill level upper surface.

FIG. 1 shows a measuring device 1 working according to the travel time, measuring method for ascertaining fill level F of a medium 7. Measuring device 1 is mounted via a nozzle on a container 5. The illustrated measuring device 1 comprises: a transmitting/receiving element 6 radiating freely into the process space; and a measurement transmitter 9. The measurement transmitter 9 includes: at least one transmitting/receiving unit 3, which produces and receives the measuring signals; a control/evaluation unit 2, which serves for signal processing of the measuring signals and for control of the measuring device 1; and a communication unit 4, which controls communication via a bus system as well as the energy supply of the measuring device 1. Integrated in the control/evaluation unit 2 is, for example, a memory element, in which measurement parameters and echo parameters are stored and in which measuring factors and echo factors are stored. The transmitting/receiving element 6 is, for example, a horn antenna in this embodiment; however, it can be in any known antenna form, such as e.g. a rod- or planar antenna. In the transmitting/receiving unit 3, a measuring signal is produced, for example, in the form of a high-frequency transmission signal S, and radiated via the transmitting/receiving element 6 in a predetermined radiation characteristic in the direction of medium 7. After a travel time t dependent on the traveled distance x, the transmission signals S reflected on the boundary surface 8 of the medium 7 are received back by the transmitting/receiving element 6 and the transmitting/receiving unit 3 as reflection signals R. The subsequent control/evaluation unit 2 determines from the reflection signals R an echo function 10, which shows the amplitudes of the echo signals of the reflection signals R as a function of the traveled distance x or the corresponding travel time t. By analog/digital conversion and filtering of the analog echo function, respectively the echo curve 10, a digitized envelope curve 11 is produced.

An envelope curve 11 showing the measuring situation in the container 5 is plotted in FIG. 1 as a function of travel distance x of the transmission signal S. For better understanding, reference lines are associated with the corresponding echo signals in the envelope curve 11, so that cause and effect can be easily seen. The beginning region of the envelope curve 11 shows the decay behavior, or the so-called ringing, which can arise due to multiple reflections or also from accretions in the transmitting/receiving element 6 or in the nozzle. Furthermore, the beginning region of the envelope curve 11 shows an echo signal 14, which is caused by the disturbance echo K of the incoming flow, or filling stream, of the medium 7. There are in solid material applications, i.e. in the case of bulk goods, also disturbing echoes K caused by the forming of hollow spaces (not shown) in the material.

In today's state of the art, there are different approaches for detecting the exact position of the wanted echo signal in an echo function 10 or digital envelope curve 11. Depending on the exact ascertaining of the measured position of fill level F in the envelope curve 11 is the accuracy of measurement that can be achieved with this echo measuring principle under the given measuring conditions.

FIG. 2 shows a pulse radar, fill level measuring device 1 shown, which determines distance by direct measurement of the travel time of the microwave pulse as transmission signal S radiated from the transmitting element 6 and reflected from the surface 8 of the medium 7 to be measured. Pulse radar, fill level measuring devices 1 work in the time domain and therefore require no Fast Fourier analysis, which is characteristic for frequency modulated continuous wave (FMCW) radar. The travel time t of the microwave pulses lies, for a distance of a few meters, in the nano second range. For this reason, one requires, as already mentioned, a special time transformation method, in order to be able to measure the very small time differences between two pulses exactly. A slow motion picture of the microwave pulses with an expanded time axis is necessary. The pulse radar-fill-level measuring device 1 uses a uniform, periodically recurring transmission signal S with a high pulse repetition frequency. Through a sequential sampling method for time expansion of the time axis of the received signals, respectively response signal R, the extremely fast and uniform signals are transformed into an evaluatable, expanded, time signal, the so called intermediate frequency signal IF. The periodic response signal R is composed of the transmission signal S itself, at least one wanted echo W and at least one disturbance echo, or multi-echo, K. The intermediate frequency signal IF is similar, in such case, to an ultrasonic signal. The microwave pulse, of, for example, 6.3 GHz, is transformed by means of the sequential sampling method into an intermediate frequency IF of, for example, 76 kHz and the pulse repetition frequency of, for example, 3.5 MHz is reduced, thus, to a frequency of 40 Hz.

The echoes of a pulse radar are individually separated and isolated in time from one another. This means the pulse radar is better suitable for handling multi-echoes and disturbing echoes, which occur often in process- and bulk goods containers.

The frequencies used in the case of radar, fill level measuring device 1 were selected by the manufacturers based on license considerations, permitting opportunities, the availability of microwave components and expected technical advantages. The different transmitting frequencies of the antenna 6 of fill-level measuring devices 1 are applied matched to the application and to the measuring situation. The achievable accuracy of a pulse radar, fill-level measuring device 1 depends on the application, the antenna design, the qualities of the HF-electronics, respectively the evaluating electronics, as well as on the signal processing software used.

The approach of the invention for determining fill level F is illustrated in FIG. 2. The solution of the invention utilizes the approach of an envelope-curve-less evaluation, in which the intermediate frequency signal IF is used directly for seeking the wanted echo W. Application of the intermediate signal IF for seeking the wanted echo W of fill level F has the advantages that the measurement signal-information is not, as in the case of application of the envelope curve 11, limited only to amplitude information.

In order to be able to utilize as much of the information of the response signal R as possible, such must, first of all, be recorded unprocessed. For the following, direct evaluation, one selects the generally valid approach that, for each sensor principle, the analog response signal R results from the earlier sent test signal T by means of a model parameters MP.

From this, the following equation can be derived:

W=MP*T

For the task definition of the fill level measuring technology, the model parameter MP can be expressed in a virtually static environment as a linear, time invariant system.

The model parameter MP is, however, dependent on all reflections of the test signal T, respectively transmission signal, in the container 5, which are located within line of sight of the sensor 6. The received response signals A follow from the geometry of the container 5, fill level F and different parasitic effects. Furthermore, the response signals R differ in size and in form. The fill level upper surface represents, for example, in the ideal case, an infinitely expanded surface. In contrast, accretion on the edge, a stirring blade or, generally, installed objects form point- or arc shaped reflectors as disturbance signal K.

This situation is illustrated in FIG. 3. A planar area delivers as response signal R a wanted echo W in the form of a uniform, sinusoidal, pulse packet. In contrast, a disturbance echo K delivers as response signal R a non-uniform pulse packet.

For example, a nozzle edge 18 represents an annular reflector. Thus, the different response signals R permit distinguishing, whether the reflected signal is coming from the planar fill level of upper surface 8, i.e. it is the wanted echo W, or involves disturbance echo signals, i.e. disturbing echoes K, from a disturbing element 12, 13,14,15,16, 18. This basic principle is used here for selecting and identifying the wanted echo W of fill level F.

The method for detecting the wanted echo signal W is shown in FIG. 4 and is put into practice, for example, as described in method steps as follows:
Sampling and registering the response signal R for a selected test signal S or comparison parameters MP derived therefrom.
comparison of the response signal R or the therefrom derived comparison parameters RMP with a series of comparison signals C or therefrom derived comparison parameters CMP. The comparison signals C are expected response signals R for the selected test signal S for a wanted echo W produced by fill level upper surfaces.
determining the agreement probabilities P of the recorded response signal R for the test signals based on the signals or the therefrom derived comparison parameters CMP.
In the case of exceeding a fixed probability value P, the associated fill level F is detected and output as measured value.
If the set probability value P is achieved for no comparison signal C, then the measuring is repeated.

The test signals S can be, to the extent desired, amplitude- and angle modulated, baseband- or bandpass signals. Preferably used are ramp shaped, frequency modulated signals, so called chips, baseband pulses or with pulse shape modulated, monofrequent, high frequency signals.

Comparison signals V can be obtained using automated parametric analyses e.g. by means of EM simulations or systematized test measurements and, in given cases, their interpolation. They can be stored e.g. in a large database with the associated test signals and cataloged according to application.

Training is not limited only to the learning phase L but, instead, can also include steady, systematic expansion and improving of the database content through new findings from test measurements and simulations.

The agreement probability P specifies with which probability the response signal R originates as a pulse packet in the intermediate frequency range IF from a flat reflector, respectively the surface 8 of the medium 7. In FIG. 3, the comparison algorithm has calculated, in this connection, the probability values of 97% for the pulse packet of the wanted echo W in the upper part of the figure and 6% for the pulse packet of the disturbing echo K from the stirring blade 15 in the lower part of the figure.

A direct comparison of the response signal R of a measurement with a series of comparison signals C can, depending on sensor embodiment 6, be very complicated and inefficient. Long response signals R with many sampled values would require much memory capacity for comparison signals C and response signal R as well as computationally intensive comparison algorithms. By modeling the test signals S, respectively comparison signals C, their essential content can be combined into a few comparison model parameters CMP, which require in the sensor 6, clearly, less memory capacity. If, after each measurement, the modeling for the response signal R is repeated, then, instead of the disturbance signals K and reflected signals R, their response model parameters RMP can be compared with the stored comparison model parameters CMP. It is to be expected that the quite simple geometry of an infinity surface 8 of fill level F of a medium 7 can be described with simple models and, thus, for modeling and a comparison of the model parameters MP, CMP, RMP, as a whole, less computing power is required than for the comparison of longer response signals R and comparison signals C.

The modeling corresponds to an estimation of the response operator. For this, for example, the modeling methods are used or can be correspondingly derived from:
Parametric methods;
neural networks;
subspace methods, e.g. MUSIC; and
methods of adaptive beam forming.

The parametric methods are based on a certain form of the distribution function of the probability density and then optimize their parameters.

The subspace algorithm MUSIC (multiple signal classification) utilizes the orthogonality occurring in the ideal case between the eigenvectors of the noise subspace and the spatial group response associated with searched directions of incidence. The MUSIC algorithm places no special requirements on the form of the spatial pulse response of the group. In special cases, e.g. a linear antenna group, calculation of the complete spectrum can be omitted.

In the subspace methods, there first occurs an estimate of the order, i.e. an estimation of the number of targets. In the ideal case, the eigenvalues, which can be associated with the reflection signals R, can be uniquely isolated from the eigenvalues belonging to the noise: The noise eigenvalues are all the same size, while the eigenvalues of the reflection signal are larger. This situation can be utilized for estimating the number of received reflection signals. With the help of the so separated subspaces, the targets can be resolved, even in the case of small differences between disturbing echoes K and wanted echo W. In the comparison with maximum likelihood methods, subspace methods require a smaller computing power, a fact especially favorable for the use of subspace methods in process automation, where field devices 1 are operated with low power due to the required intrinsic safety, so that energy availability is limited. The echo separation capability means also achieving a higher robustness against disturbances, for example, disturbances caused by components installed in the container 12, material deposits 13 and/or stirring mechanisms 14 in the container 5, since the reflections of the disturbing echoes K can be distinguished from reflections of the wanted echo W. The large dynamic range of the radar signals and the ultrasonic signals and the sensor inaccuracies do, in given cases, make an exact subspace separation difficult. This means that other signal processing methods must be examined for increasing the robustness of the angle separation, methods such as calibrating and decorrelation.

In the case of neural networks as modeling methods, the causal relationships between the input signal, or test signal, and the corresponding, detected, response signals R, or output variables, are stored in the form of at least one transfer function, or model parameter.

The method of the invention has, furthermore, the advantages that the base knowledge concerning the measuring procedure remains in the company and does not have to be disclosed, since the comparison signals produced in the learning phase always represent only a small part of the database content. Furthermore, are updates and therewith measures for increasing efficiency of devices 1 already in operation can be carried out by replacement or supplementation of the locally stored comparison signals C and modeling methods, respectively their model parameters MP.

The method of the invention is not only useful in freely radiating microwave measuring devices 1, such as shown in FIGS. 1 and 2, but, also in additional travel time measurement systems, such as, for example, TDR measuring devices or ultrasonic measuring devices. In the case of application of ultrasonic measuring devices, the intermediate signal does not have to be produced, since the frequencies of the ultrasonic signal lie in a frequency working range of the electronics of the signal processing unit.

### LIST OF REFERENCE CHARACTERS

1 field device, measuring device

2 control/evaluation unit

3 transmitting/receiving unit

4 communication unit

5 container

6 transmitting/receiving element, sensor

7 medium

8 boundary surface, upper surface

9 measurement transmitter

10 echo function, echo curve

11 envelope curve

12 components installed in a container

13 material deposit

14 stirrer

15 material inflows

16 unsteady surface

17 communication/energy supply line

18 nozzle edge

Amp amplitude value

S transmission signal, test signal

R response signal

W reflection signal, wanted echo

K disturbance signal, disturbance echo

N noise

C comparison signals

IF intermediate frequency signal

RIF response-intermediate frequency signal

CIF comparison-intermediate frequency signal

P agreement probability, probability value

G predetermined limit value

x path, traveled distance

t time, travel time

F fill level

O operational phase

L learning phase

MP model parameter, comparison parameter

CMP comparison model parameter

MPS model parameter set

RMP response model parameter

1-9. (canceled)

10. A method for ascertaining and monitoring fill level of a medium in a container by means of a field device with a travel time measuring method, comprising the steps of:
determining, in a learning phase, application- and device referenced test signals and response signals expected from a fill level surface;
ascertaining, from the application- and device referenced test signals and the expected response signals from a fill level upper surface in the learning phase, application- and device referenced comparison signals;
receiving, in an operational phase, test signals which are transmitted toward the medium and application- and device referenced, response signals;
comparing, in an operational phase, by means of a comparison algorithm, the application- and device referenced comparison signals the application- and device referenced, response signals and ascertaining a value for an agreement probability; and
ascertaining the fill device, in the operational phase, upon exceeding the ascertained value of the agreement probability above a predetermined limit value, and outputting, as a measured value and/or, in the case of subceeding, or falling beneath, the predetermined limit value, a new test signal which is transmitted for renewed ascertaining of an application- and device referenced response signal.

11. The method as claimed in claim 10, wherein:
in the learning phase, from the application- and device referenced, comparison signals, by means of a modeling method, corresponding comparison model parameters are derived and stored in the fill-level measuring device as a model parameter set.

12. The method as claimed in claim 11, wherein:
in the operational phase, from the application- and device referenced, response signals, by means of the modeling methods, corresponding current response model parameters are derived and the agreement probability is ascertained by means of a comparison algorithm, which compares the current response model parameter with the comparison model parameters stored in the model parameter set.

13. The method as claimed in claim 11, wherein:
the response signals and/or comparison signals are converted by means of sequential sampling into low frequency, response, intermediate frequency signals and/or comparison, intermediate frequency signals; and
these intermediate frequency signals are digitized by means of an analog digital transformation.

14. The method as claimed in claim 11, wherein:
as a modeling method, parametric analyses are performed in the learning phase, e.g. by means of electromagnetic simulations, or systematized test measurements.

15. The method as claimed in claim 10, wherein:
as modeling method, parametric analyses (e.g. by means of electromagnetic simulations or systematized test measurements in the learning phase are performed continuously and systematically in the operational phase.

16. The method as claimed in claim 10, wherein:
for deriving model parameters by means of modeling methods, parametric methods, neural networks, subspace methods and/or adaptive beam forming methods are used.

17. The method as claimed in claim 10, wherein:
the ascertained comparison signals are cataloged application specifically and/or device specifically in a database and stored associated with the belonging test signals.

18. The method as claimed in claim 10, wherein:
amplitude- and/or angle modulated baseband signals, ramp shaped, frequency modulated signals, baseband pulses or monofrequent high frequency signals modulated with pulse shape are applied as test signals.
